(19) United States
(12) Patent Application Publication
(10) Pub. No.: US 2025/0277683 A1
(43) Pub. Date: Sep. 4, 2025

(54) System for determining rotational information of a member

(71) Applicant: NTN EUROPE, Annecy (FR)

(72) Inventors: Alexandre BAUDU, Annecy (FR); Siegfried RUHLAN, Annecy (FR)

(21) Appl. No.: 19/063,344

(22) Filed: Feb. 26, 2025

(30) Foreign Application Priority Data
Feb. 29, 2024 (FR) 2402055

(51) Int. Cl. G01D 11/02; G01D 5/244; G01D 5/245; G01D 11/24

(52) U.S. Cl. CPC G01D 11/02; G01D 5/24438; G01D 5/2451; G01D 11/245

(57) ABSTRACT

The invention relates to a system for determining information about the rotation of a member (1) about an axis (R) by means of a device comprising an encoder (11, 12) carried by a body (50) connected in rotation to said member, said encoder having a track (11a, 12a) capable of emitting a periodic signal representative of the rotational displacement of said member; a sensor comprising a sensitive pattern (15, 16) arranged at a reading distance (d) from the track (11a, 12a) to deliver the information as a function of said displacement; said system comprising a casing (17) in which said member is rotatably mounted by means of a bearing (18) and, fixed in the casing (17), a module (19) on which the sensor is associated, the guide bearing (18) being carried by the module (19), a spacer (26) for adjusting the reading distance (d) being disposed between the body (50) and the guide bearing (18).

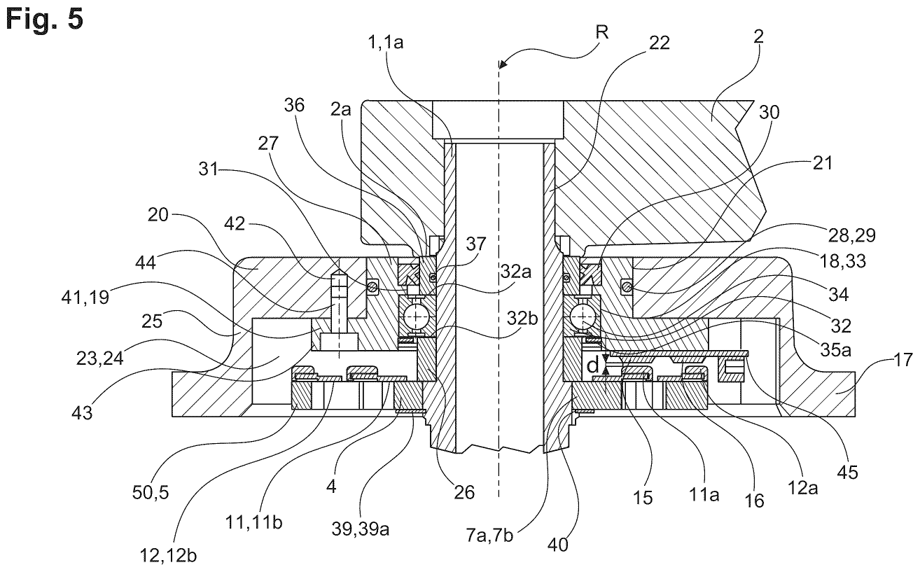

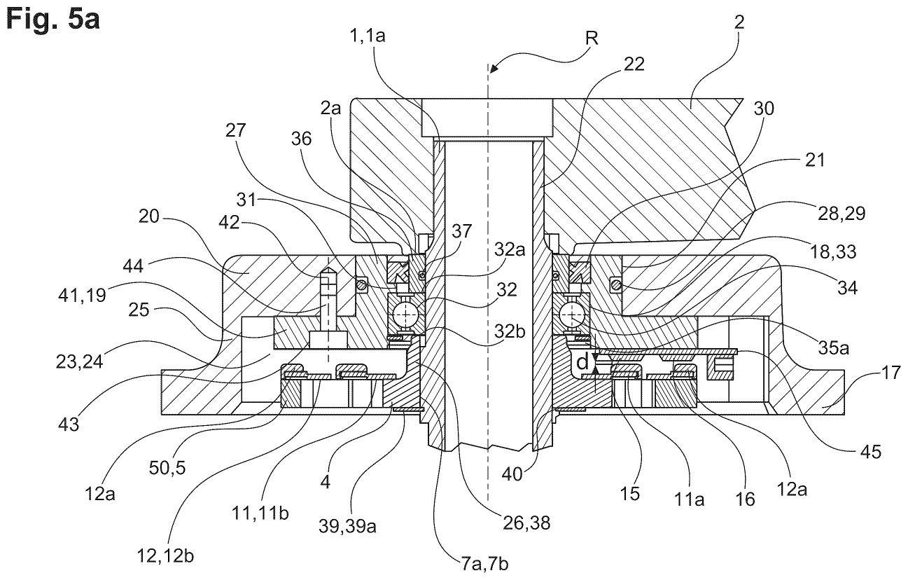

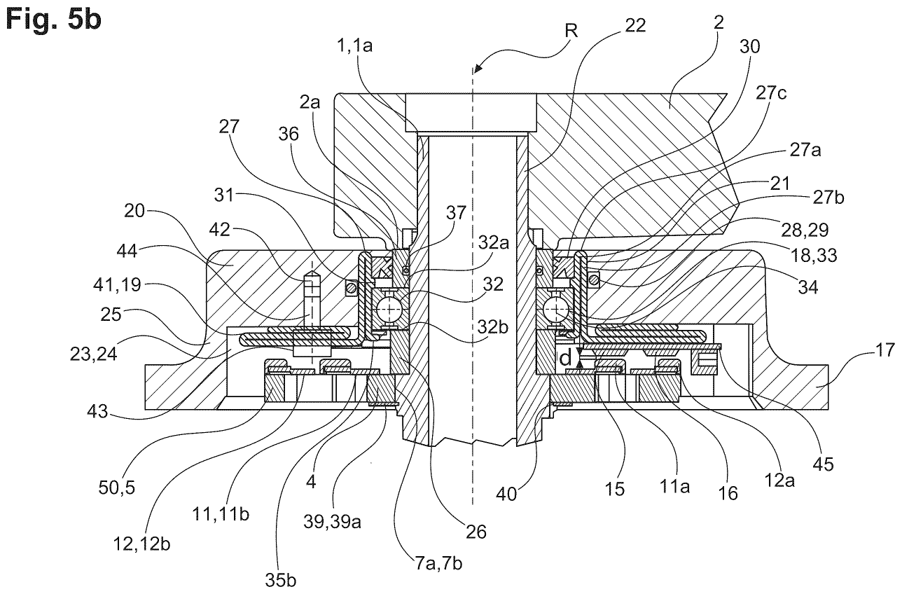

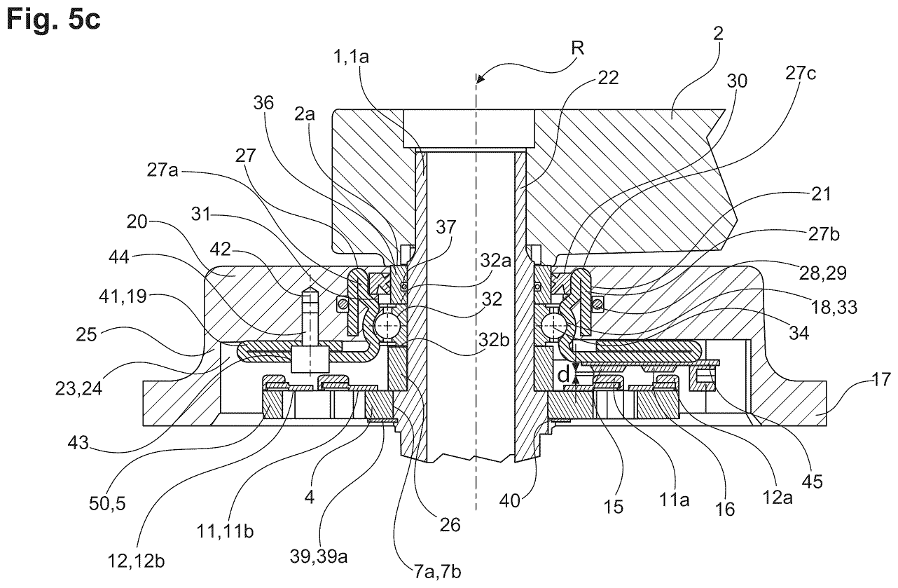

FIG. 5

The invention relates to a system for determining rotational information of a member about an axis by means of a device comprising an encoder and a sensor.

In particular, the encoder is carried by a body connected in rotation with the member, while presenting a track capable of emitting a periodic signal representative of the rotational displacement of said member, the sensor comprising a sensitive pattern disposed at a reading distance from the track to deliver rotational information as a function of said displacement.

According to a particular application, the system can be used to determine a torque applied between two rotating members, in particular those integrated in a transmission of an engine torque to a vehicle, for example between the electric motor or pedal assembly and the mechanical transmission of an electrically-assisted bicycle.

For this purpose, it is known to use a test body having an inner section connected in rotation with a member, and an outer section extending around the inner section and having means for coupling said body to the second member, said sections being connected concentrically around the axis by a deformable structure which is arranged to transmit a torque between the members while allowing an angular displacement between said sections as a function of the torque applied between said members.

Such a test body can be instrumented with two concentric encoders, each presenting a track. In particular, each of the tracks presents a succession of pairs of North and South poles to form a multipolar magnetic track delivering a pseudo-sinusoidal magnetic signal.

The sensor comprises two sensitive patterns respectively arranged at reading distance from a track, said sensor comparing the displacements of the sections to determine the applied torque.

Documents FR-2 816 051, FR-2 821 931 and FR-2 862 382 describe the comparison of such signals to determine an angular gap between the sections, and therefore the torque applied, as it induces said angle by twisting the deformable structure.

In known systems, there is the problem of setting the reading distance between the sensitive pattern and the corresponding encoder track, which must be done precisely.

In particular, for torque determination, the reading distance must be stable and equivalent for both sensors, so as not to distort the determination.

The aim of the invention is to improve the prior art by proposing, in particular, a determination system that makes it possible to ensure the reliability of the reading distance of sensitive patterns, and this in a particularly simple way.

To this end, the invention proposes a system for determining information about the rotation of a member about an axis by means of a device comprising:
an encoder carried by a body connected in rotation with said member, said encoder having a track capable of emitting a periodic signal representative of the rotational displacement of said member;
a sensor comprising a sensitive pattern arranged at a reading distance from the track to deliver information as a function of said displacement;
   said system comprising a casing in which said member is rotatably mounted by means of a guide bearing and, fixed in the casing, a module on which the sensor is associated, the guide bearing being carried by the module, a spacer for adjusting the reading distance being disposed between the body carrying the encoder and said bearing.

Further objects and advantages of the invention will become apparent from the following description, made with reference to the appended figures, in which:

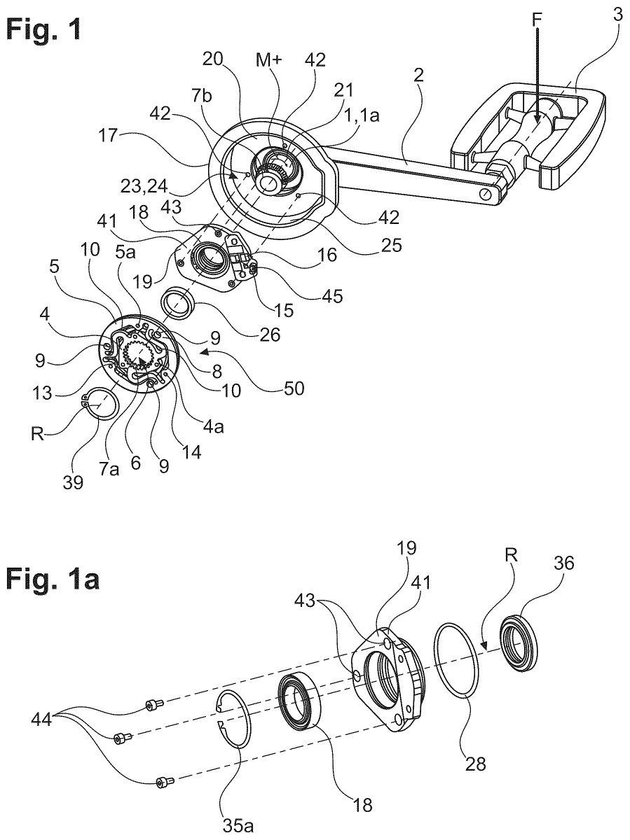

FIG. 1 is a partial exploded perspective view of the pedal assembly of an electrically-assisted bicycle equipped with a system according to the invention for determining the rotation torque between two members rotating about an axis of rotation;

FIG. 1a shows the assembly of the rolling bearing in the module;

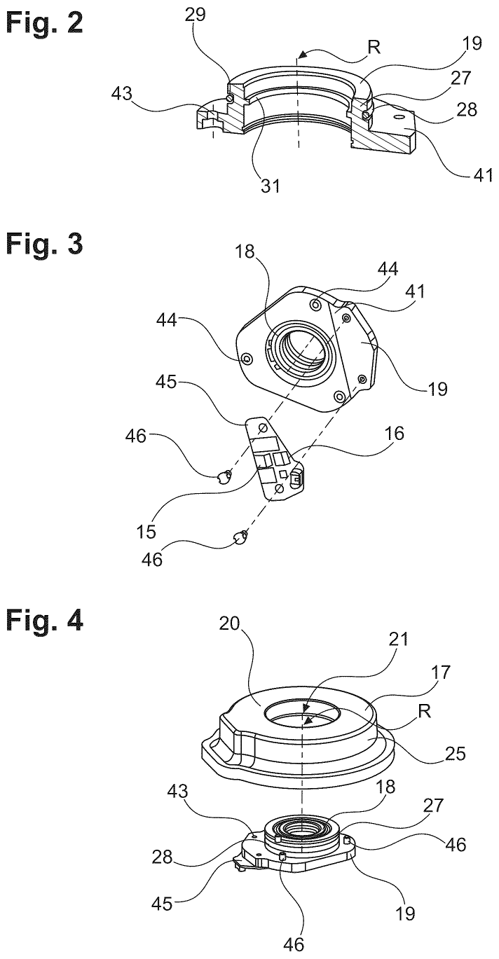

FIG. 2 is a perspective and axial sectional view of the module shown in FIG. 1;

FIG. 3 shows an exploded perspective view of assembly of the sensor on the module shown in the previous figures;

FIG. 4 shows an exploded-perspective view of the mounting in the casing of the module/bearing/sensor assembly shown in the previous figures;

FIG. 5 shows a partial axial section of the pedal assembly of an electrically-assisted bicycle equipped with the determination system shown in the previous figures;

FIG. 5a,

FIG. 5b and

FIG. 5c show, in a view similar to FIG. 5, a pedal assembly of an electrically-assisted bicycle equipped with a determination system according to a respective variant of embodiment of the invention.

In relation to these figures, we describe below a system for determining information about the rotation of a member 1 about an axis R.

In this description, spatial positioning terms are taken in reference to the axis R of rotation. In particular, the terms “inner” and “outer” refer to an arrangement respectively close to and at a distance from this axis R, and the terms “axial” and “radial” refer to an arrangement respectively following this axis R and moving away from or towards it. Furthermore, the terms “internal” and “external” refer to an arrangement on one side and the other respectively along the R axis, in particular downwards and upwards in FIG. 5.

According to a particular application, the system enables the determination of a torque applied between two members 1 rotating around the axis R, said members being integrated in a transmission of a motor torque to a vehicle, for example at the pedal assembly of an electrically assisted bicycle.

In other applications, the system can be used to determine different types of information, such as the position or speed of rotation of a rotating member.

According to the embodiment shown, one of the members 1 is equipped with a part 2 for actuating its rotation. In particular, FIG. 1 shows a pedal assembly of an electrically-assisted bicycle comprising a crank 2 equipped with a pedal 3, said crank being mounted on a shaft 1a driven in rotation about the axis R to form a member 1 for applying a pedaling torque M+ in the pedaling direction.

The system comprises a test body 50 which allows the transmission of the pedaling torque M+ to the second member. In particular, the second member may comprise a sleeve arranged concentrically around the shaft 1a, said sleeve being connected, for example, to a satellite carrier of an epicyclic gear train of a motorized gearbox, exerting a rotation torque oriented in a direction opposite to that of the pedaling torque M+.

In this application, the pedaling force F at the end of pedal 3 to be considered according to standard EN15194: 2017 is 1,500 N which, with a crank 2 length of 165 mm, generates a pedaling torque M+ of the order of 250 Nm. In particular, the torque to be transmitted by the test body is only in one direction of rotation (that represented by the M+ arrow on the figures), as the other direction corresponds to the freewheel of the bicycle.

The test body 50 has an inner section 4 connected in rotation to the first member 1, as well as an outer section 5 extending around the inner section 4 and having means for coupling said test body to the second member.

In relation to the figures, the inner section 4 comprises a bore 6 equipped with means for coupling to the shaft 1a, in particular in the form of splines 7a arranged to engage with complementary ribs 7b formed circumferentially and in relief on the periphery of said shaft.

With regard to coupling to the second member, FIG. 1 shows an outer section whose inner circumferential wall has at least one radial lobe 8 which is equipped with a means 9 for fixing said outer section to a sleeve of said second member, as described previously. In particular, three lobes 8 at 120° are provided, each of which has a hole 9 for attachment, in particular by a pin or by screwing into a complementary hole in such a sleeve.

Sections 4, 5 are connected concentrically around the axis R by a deformable structure which is arranged to transmit a torque between the members, while allowing angular displacement between said sections, depending on the torque applied between said members.

In particular, the torque resulting from the pedaling torque M+ on the inner section 4 and the torque applied by the second member on the outer section 5 induces a torsion between sections 4, 5, and therefore a relative angular displacement of said sections according to a torsion angle which is a function of said torque.

In the embodiments shown, the deformable structure comprises a set of branches 10 angularly distributed between the sections 4, 5. In particular, the branches 10 and the sections 4, 5 are formed in one piece, notably by stamping and/or cutting a blank of metallic material.

The branches 10 are inclined against the direction of rotation, creating a lever arm which, by applying tensile stress to the branches 10, reduces stresses very effectively, with a counterpart increase in stiffness.

In FIG. 1, the test body 50 comprises three branches 10, each of which has a curved geometry designed to ensure an effective lever arm effect while at the same time taking up little radial space, the lobes 8 each extending radially into an outer bend of a respective branch 10.

The system includes a device for determining the angle between sections 4, 5, which, particularly by taking into account the stiffness of the deformable structure, is a function of the torque applied.

For this purpose, the device comprises two concentric encoders carried by a respective section 4, 5 of the test body 50, including an inner encoder 11—respectively an outer encoder 12—connected in rotation with the inner section 4—respectively the outer section 5—, each having a track 11a, 12a capable of emitting a signal representative of the rotational displacement of a respective member 1.

In other applications, the body 50 can be equipped with one or more encoders 11, 12 to determine information about the rotation of the member 1, such as about its position or speed of rotation.

In the embodiment shown, each encoder 11, 12 is fixed to a respective section 4, 5 and carries a respective inner 11a and outer 12a magnetic track which is able to emit a periodic signal representative of the rotational displacement of the corresponding section 4, 5.

Each of the encoders 11, 12 is carried by a respective inner 11b and outer 12b frame, the inner 4—respectively outer 5—section having means for fastening the inner 11b—respectively outer 12b—frame to it, notably in the form of screwing or riveting orifices 4a, 5a.

In relation to FIG. 1, the inner section 4 has an outer circumferential wall provided with three radial lobes 13, and the outer section 5 has three radial lobes 14 which are formed on its inner circumferential wall while being angularly offset from the lobes 8 for attachment to the second member, each section 4, 5 having three attachment orifices 4a, 5a arranged at 120° to one another and formed on each of the lobes 13, 14.

In one embodiment, a succession of pairs of North and South poles are magnetized on a respective encoder 11, 12 to form a multipolar magnetic track 11a, 12a capable of emitting a pseudo-sinusoidal magnetic signal.

The encoders 11, 12 can each comprise an annular matrix, for example made from a plastic or elastomer material, in which magnetic particles are dispersed, in particular ferrite particles or rare-earth particles such as NdFeB, said particles being magnetized to form the magnetic tracks 11a, 12a.

The determination device also includes a sensor comprising at least two sensitive patterns, inner 15 and outer 16 respectively, each arranged at a reading distance d from the inner 11a and outer 12a track respectively, so as to provide information on the rotation of the corresponding member 1 as a function of its displacement.

In the embodiments shown, each sensitive pattern 15, 16 is arranged to provide a signal representative of the angular position of the corresponding encoder 11, 12, and the sensor uses said signals to compare the displacements of the corresponding sections 4, 5, in order to determine an angular gap between said sections, which is a function of the torque applied.

According to one embodiment, each pattern 15, 16 may comprise at least two sensitive elements, in particular a plurality of aligned sensitive elements, as described in documents FR-2 792 403, EP-2 602 593 and EP-2 602 594.

The sensitive elements can be based on a magnetoresistive material whose resistance varies according to the magnetic signal of the track 11a, 12a to be detected, for example of the AMR, TMR or GMR type, or a Hall-effect probe.

In one embodiment, the angular position can be determined incrementally by means of the signal emitted by a magnetic track 11a, 12a. In particular, the sensitive patterns 15, 16 can be arranged to deliver quadrature incremental square-wave signals, the sensor comprising comparison means which have counting means indicating the angular position of each of the encoders 11, 12, as well as subtraction means for calculating the difference between said angular positions, in particular as described in documents FR-2 816 051, FR-2 821 931 and FR-2 862 382.

In one embodiment, the angular position can be determined absolutely, i.e. relative to a reference position, by providing a secondary magnetic track or a specific coding on the washer of an encoder 11, 12, whereby a sensor pattern can be arranged at a reading distance d from said track or said coding.

In relation to the figures, the determination system further comprises a casing 17 in which the member 1 is rotatably mounted by means of a guide bearing 18 and, fixed in the casing 17, a module 19 on which the sensor is associated.

In particular, the casing 17 comprises an external wall 20 provided with a bore 21 through which the rotating shaft 1a is rotatably mounted by means of the bearing 18, said rotating shaft having an end 22 projecting from said external wall which is equipped with the crank 2 for applying a pedaling torque M+.

The casing 17 has a cavity 23 forming a housing 24 in which the module 19 and the test body 50 are arranged. In the figures, the external wall 20 of the casing 17 is surrounded by a skirt 25 which delimits the housing 24, the module 19 and the sensor being arranged in said housing by being circumferentially surrounded by said skirt, so as to be integrally contained within said casing.

In addition, the guide bearing 18 is carried by the module 19, and a spacer 26 for adjusting the reading distance d is arranged between the test body 50 and said bearing.

This arrangement makes the reading distance d, and therefore the accuracy of the signals delivered, more reliable, as it enables the positioning of the bearing 18 and the sensitive patterns 15, 16 relative to the module 19, the positioning of the tracks 11a, 12a relative to the body 50, and the distance d to be defined directly by the length of the spacer 26.

In the embodiments shown, the module 19 comprises a barrel 27 which has an outer wall arranged in the bore 21 and an inner wall carrying the guide bearing 18.

To prevent leakage of lubricant into the housing 24 of the casing 17, on the one hand, and penetration of external contaminants such as water, dust and/or sludge into said housing, on the other hand, the outer wall of the barrel 27 is fitted with a sealing element 28 at its interface with the bore 21.

In the embodiments shown, the system comprises an O-ring 28 which is arranged in an annular groove 29 formed for this purpose on the outer wall of the barrel 27 (FIGS. 2, 5, 5a) and/or on the inner wall of the bore 21 (FIGS. 5b, 5c), in order to seal the interface between the module 19 and said bore.

Similarly, the inner wall of the barrel 27 is equipped with an annular sealing element 30 at its interface with the member 1, said sealing element resting axially on an annular flange 31 formed for this purpose on said inner wall.

In FIGS. 5 and 5a, the module 19 is formed by molding, in particular of a polymer material. In FIGS. 5b and 5c, the module 19 is formed by stamping a sheet plate made of a metallic material, the barrel 27 being formed by two axial inner 27a and outer 27b walls joined together by an external fold 27c.

The guide bearing 18 comprises an inner ring 32 mounted around the member 1 and an outer ring 33 carried by the module 19, with rolling bodies, in particular in the form of balls 34, arranged between said rings to guide their relative rotation.

In FIGS. 5, 5a and 5b, the outer ring 33 is associated with a wall of the module 19, in particular by means of a circlip-type washer 35a (FIGS. 5, 5a) or by means of an inner radial fold 35b formed by stamping an inner end of the inner wall 27a (FIG. 5b).

In FIG. 5c, the module 19 has a wall, in particular the inner wall 27a of its barrel 27, which itself forms the outer ring 33. For this purpose, the outer raceway of the balls 34 is formed by stamping into the inner wall 27a, and the annular flange 31 is formed on an external part of said raceway.

The inner ring 32 is fitted around the shaft 1a, and has an external wall 32a which is held axially on said shaft. In particular, the crank 2 has an axial stop 2a on which the external wall 32a bears, possibly via a ring 36 arranged between said stop and said wall.

Advantageously, the ring 36 is fitted onto the shaft 1a with a sealing element interposed, notably in the form of an O-ring 37.

The spacer 26 is axially supported against an internal wall 32b of the inner ring 32. In FIGS. 5, 5b and 5c, the spacer 26 is axially supported against an external wall of the body 50, as well as on a radial wall formed at the external part of the ribs 7b engaging the shaft 1a with said body.

In FIG. 5a, the spacer 26 is formed integrally with the body 50, which for this purpose has an axially extending nose 38 to form said spacer. Alternatively, the inner ring 32 may have a similar nose to form the spacer 26 and/or said spacer may comprise a shoulder formed around the shaft 1a.

In relation to the figures, the body 50 has an internal wall 39a which is held axially on the member 1 by means of a washer 39.

In particular, the washer 39 is a “circlip” type spring washer mounted in an annular groove 40 formed on the periphery of the rotating shaft 1a, and is arranged to apply an axial force to press the spacer 26 against the guide bearing 18.

In the figures, the module 19 also comprises a radially-extending 41 plate with an internal wall to which the sensor is attached.

Advantageously, the plate 41 is screwed into blind holes 42 in the casing 17. This arrangement leaves the external wall 20 of the casing 17 free of any protruding fastening elements, so as to avoid any risk of collision with the crank 2, but also to avoid the risk of lubricant leakage and/or entry of outer pollutants through any orifices passing through said external wall. In addition, the sensor is precisely positioned with reference to the axis of rotation R by fixing it directly in the casing 17, in particular by arranging the plane of the sensitive patterns 15, 16 perpendicular to the axis R.

In the figures, the plate 41 has three angularly equispaced holes 43 to enable it to be fastened to the external wall 20 by means of suitable screws 44.

The sensor is mounted on a printed circuit board 45, which is attached to the module 19. In particular, the board 45 is fixed by two screws 46 to the internal wall of the plate 41.

In the case of a module 19 formed by stamping a sheet of metallic material (FIGS. 5b, 5c), the plate 41 is formed by axially stacking at least two walls connected by folds, in order to guarantee said plate a thickness which is sufficient to ensure its rigidity, particularly with regard to screwing into the casing 17 and/or screwing in the sensor board 45. In addition, this embodiment provides sufficient tapped length for the screws for fixing the electronic board 45, while remaining set back from the encoders 11, 12.

1. System for determining rotation information of a member (1) about an axis (R) by means of a device comprising:
an encoder (11, 12) carried by a body (50) connected in rotation with said member, said encoder having a track (11a, 12a) capable of emitting a periodic signal representative of the rotational displacement of said member;
a sensor comprising a sensitive pattern (15, 16) arranged at a reading distance (d) from the track (11a, 12a) to deliver information as a function of said displacement;
said system comprising a casing (17) in which said member is rotatably mounted by means of a guide bearing (18) and, fixed in the casing (17), a module (19) on which the sensor is associated, said system being characterized in that the guide bearing (18) is carried by the module (19), and in that a spacer (26) for adjusting the reading distance (d) is disposed between the body (50) and the guide bearing (18).

2. Determination system according to claim 1, characterized in that the casing (17) comprises a bore (21) in which the member (1) is rotatably mounted, the module (19) having a barrel (27) with an outer wall arranged in said bore and an inner wall carrying the guide bearing (18).

3. Determination system according to one of claim 1, characterized in that the guide bearing (18) comprises an inner ring (32) mounted around the member (1) and an outer ring (33) carried by the module (19), rolling bodies (34) being arranged between said rings to guide their relative rotation.

4. Determination system according to claim 3, characterized in that the outer ring (33) is associated with a wall of the module (19).

5. Determination system according to claim 3, characterized in that the module (19) has a wall (27a) forming the outer ring (33).

6. Determination system according to claim 3, characterized in that the spacer (26) is axially supported against an internal wall (32b) of the inner ring (32).

7. Determination system according to claim 3, characterized in that the inner ring (32) has an external wall (32a) which is held axially on the member (1).

8. Determination system according to claim 1, characterized in that the spacer (26) is axially supported against an external wall of the body (50).

9. Determination system according to claim 1, characterized in that the body (50) has an axially extending nose (38) to form the spacer (26).

10. Determination system according to claim 1, characterized in that the body (50) has an internal wall (39a) which is held axially on the member (1) by means of a washer (39).

11. Determination system according to claim 1, characterized in that the module (19) has a radially extending plate (41), said plate having an internal wall to which the sensor is attached.

12. Determination system according to claim 11, characterized in that the plate (41) is screwed into blind holes (42) in the casing (17).

13. Determination system according to claim 1, characterized in that the sensor is implemented on a printed circuit board (45), said board being attached to the module (19).

14. Determination system according to claim 1, characterized in that the body (50) carries two concentric encoders (11, 12) each having a track (11a, 12a), the sensor comprising at least two sensitive patterns (15, 16) arranged respectively at a reading distance (d) from a track (11a, 12a).

15. Determination system according to claim 14, characterized in that the body (50) has an inner section (4) connected in rotation with the member (1), and an outer section (5) extending around the inner section (4) and having means (9) for coupling said body to a second member, said sections being connected concentrically around the axis (R) by a deformable structure (10) which is arranged to transmit a torque between the members (1) while allowing angular displacement between said sections as a function of the torque applied between said members, the encoders (11, 12) being respectively carried by a section (4, 5) and the sensor comparing the displacements of said sections to determine the applied torque.
